(19) United States
(12) Patent Application Publication
(10) Pub. No.: US 2014/0280215 A1
(43) Pub. Date: Sep. 18, 2014

(54) SYSTEM AND METHOD FOR TWO-TIERED QUESTIONNAIRE ANALYSIS

(71) Applicant: Zachary LIMACHER, Seattle, WA (US)

(72) Inventor: Zachary LIMACHER, Seattle, WA (US)

(21) Appl. No.: 13/840,886

(22) Filed: Mar. 15, 2013

(51) Int. Cl. G06F 17/30

(52) U.S. Cl. CPC G06F 17/3053
USPC 707/748

(57) ABSTRACT

A system and method for using a two-tiered weighting algorithm for analyzing answers given for a particular questionnaire. In various awards shows, sporting events, or contests with categories and multiple candidates for winning various categories, users of the system may make a set of predictions for each category. The predictions may include predictions ranked according to the user's belief in likelihood of winning. Thus, the choice a user believes is most likely to win may be ranked in a first position, the choice the user believes to be the second most likely to win may be ranked in a second position and so on. Then, each category may be assigned a weighted value for the category as well as weighted values for positions in which the user predicted the winner. Thus, an overall two-tier weighted score for the set of predications may be calculated.

### BACKGROUND

Awards shows, reality shows, elections, and sporting tournaments are enjoyed by people the world over and ever-increasing popularity in these events attracts fan participation in a multitude of different ways. As awards shows and sporting tournaments approach, fans and professional observers take notice to offer predictions of outcomes based on knowledge base and analysis. Often, various “pools” may also be utilized as a way to compare various amateurs' and experts' predictions to each other. That is, by assigning point values to correctly predicting winners of an award or sporting event, a group of people offering predictions may have their projections and predictions compared to one another via the point system in a pool. These sorts of pools are often seen surrounding popular events such as the Motion Picture Association Academy Awards or the National Collegiate Athletic Association's Basketball Tournament.

However, such pools are often one dimensional in so much as the various prediction categories are assigned equal weight and are only associated with one correct prediction. That is, to use an example from movie awards, a prediction correctly identifying a winner in a relatively unknown category may carry just as much weight as correctly predicting a well-known and often-anticipated category. Further, pools are often established as having only one correct prediction per category and give no value to secondary or tertiary choices. To this end, one-dimensional predictive scoring systems tend to obfuscate meaningful differences between sets of predictions from various people.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram of a suitable computing device and environment for practicing various aspects and embodiments of the systems and methods of the subject matter disclosed herein;

FIG. 2 shows a block diagram of a wide-area computing network utilizing the computing environment of FIG. 1 according to an embodiment of the subject matter discussed herein.

FIG. 3 is a flow chart diagram of method for establishing a questionnaire-based survey within the context of a questionnaire-based two-tiered weighting system according to an embodiment of the subject matter disclosed herein.

FIG. 4 is a flow chart diagram of method for making predictions within the context of a questionnaire-based two-tiered weighting system according to an embodiment of the subject matter disclosed herein.

FIG. 5 is a flow chart diagram of method for updating and presenting results within the context of a questionnaire-based two-tiered weighting system according to an embodiment of the subject matter disclosed herein.

FIG. 6 is a screen shot of a ranking of users in the context of a two-tiered weighting system for questionnaire analysis according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

By way of overview, the subject matter disclosed herein is related to a system and method for using a two-tiered weighting algorithm for analyzing answers given for a particular questionnaire. In various awards shows, sporting events, or contests with categories and multiple candidates for winning various categories, users of the system may make a set of predictions for each category. The predictions may include predictions ranked according to the user's belief in likelihood of winning. Thus, the choice a user believes is most likely to win may be ranked in a first position, the choice the user believes to be the second most likely to win may be ranked in a second position and so on. Then, each category may be assigned a weighted value for the category as well as weighted values for positions in which the user predicted the winner. Thus, based on a first tier weighting of categories and a second tier weighting of positions within each category, an overall two-tier weighted score for the set of predications may be calculated. In this manner, various combinations of contests and pools may be created for users to compete against each other in a more in depth manner than simply counting correctly predicted questions having equal value. These and other aspects of the systems and methods described herein are further illustrated and described below with respect to FIGS. 1-6.

FIG. 1 and the following discussion are intended to provide a brief, general description of a suitable computing environment in which the subject matter disclosed herein may be implemented. Although not required, aspects of the systems and methods described herein may be practiced in the general context of computer-executable instructions, such as program modules, being executed by a computer device. Generally, program modules include routines, programs, objects, components, data structures, etc., that perform particular tasks or implement particular abstract data types. Such program module may be embodied in both a transitory and/or a non-transitory computer readable medium having computer-executable instructions. Moreover, those skilled in the art will appreciate that the systems and methods herein may be practiced with other computer system configurations, including hand-held devices, cellular or mobile telephones, smart phones, smart tablets, multiprocessor systems, microprocessor-based or programmable consumer electronics, network PCs, minicomputers, mainframe computers, and the like. The systems and methods herein may also be practiced in distributed computing environments where tasks are performed by remote processing devices that are linked through a communications network. In a distributed computing environment, program modules may be located in both local and remote computing devices.

With reference to FIG. 1, an exemplary system for implementing the systems and methods disclosed herein includes a general purpose computing device in the form of a conventional personal computer 120, including a processing unit 121, a system memory 122, and a system bus 123 that couples various system components including the system memory to the processing unit 121. The system bus 123 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The system memory includes read only memory (ROM) 124 and random access memory (RAM) 125. A basic input/output system (BIOS) 126, containing the basic routines that help to transfer information between elements within the personal computer 120, such as during start-up, is stored in ROM 124. The personal computer 120 further includes a hard disk drive 127 for reading from and writing data to a hard disk, not shown, a magnetic disk drive 128 for reading from or writing data to a removable magnetic disk 129, and an optical disk drive 130 for reading from or writing data to a removable optical disk 131 such as a CD ROM, DVD-ROM, Blu-Ray™ or other optical media. The hard disk drive 127, magnetic disk drive 128, and optical disk drive 130 are connected to the system bus 123 by a hard-disk-drive interface 132, a magnetic-disk-drive interface 133, and an optical-drive interface 134, respectively. The drives and their associated computer-readable media provide nonvolatile storage of computer readable instructions, data structures, program modules and other data for the personal computer 120. Although the exemplary environment described herein employs a hard disk, a removable magnetic disk 129 and a removable optical disk 131, it should be appreciated by those skilled in the art that other types of computer-readable media which can store data that is accessible by a computer, such as flash memory cards, digital versatile disks, random access memories (RAMs), read only memories (ROM), and the like, may also be used in the exemplary operating environment.

A number of program modules may be stored on the hard disk, magnetic disk 129, optical disk 131, ROM 124 or RAM 125, including an operating system 135, one or more application programs 136, other program modules 137, and program data 138. A user may enter commands and information into the personal computer 120 through input devices such as a keyboard 140 and pointing device 142. Other input devices (not shown) may include a microphone, game pad, satellite dish, scanner, voice-command module, motion-detection input system or the like. These and other input devices are often connected to the processing unit 121 through a serial port interface 146 that is coupled to the system bus, but may be connected by other interfaces, such as a parallel port, wireless-communication interface, network interface or a universal serial bus (USB). A monitor 147 or other type of display device is also connected to the system bus 123 via an interface, such as a video adapter 148. One or more speakers 157 are also connected to the system bus 123 via an interface, such as an audio adapter 156. In addition to the monitor and speakers, personal computers typically include other peripheral output devices (not shown), such as printers, second monitors, surround sound speakers, lighting modules, or additional linked computing devices

The personal computer 120 may also operate in a networked environment using logical connections to one or more remote computers, such as remote computers 149 and 160. Each remote computer 149 or 160 may be another personal computer, a server, a router, a network PC, a peer device or other common network node, and typically includes many or all of the elements described above relative to the personal computer 120, although only a memory storage device 150 or 161 has been illustrated in FIG. 1. The logical connections depicted in FIG. 1 include a local area network (LAN) 151 and a wide area network (WAN) 152, which may also include a wired or wireless network 173 including but not limited to the World Wide Web, a cloud based public or private network, a Global System for Mobile (GSM) network, and a Code Division Multiple Access (CDMA) network. Such networking environments are commonplace in offices, enterprise-wide computer networks, intranets, Internet and the mobile networks.

As depicted in FIG. 1, the remote computer 149 communicates with the personal computer 120 via the local area network 151. The remote computer 160 communicates with the personal computer 120 via the wide area network 152. The remote computer 160 communicates with the personal computer 120 via the wireless network.

When used in a LAN networking environment, the personal computer 120 is connected to the local network 151 through a network interface or adapter 153. When used in a WAN networking environment, the personal computer 120 typically includes a modem 154, Network Interface Card (NIC) or other means for establishing communications over the wide area network 152, such as the Internet. The modem 154, which may be internal or external, is connected to the system bus 123. In a networked environment, program modules depicted relative to the personal computer 120, or portions thereof, may be stored in the remote memory storage device. It will be appreciated that the network connections shown are exemplary and other means of establishing a communications link between the computers may be used. The computing environment described in FIG. 1 may be used in conjunction with a wide-area computing network as next discussed with respect to FIG. 2.

FIG. 2 shows a block diagram of a wide-area computing environment 200 utilizing the computing environment 100 of FIG. 1 according to an embodiment of the subject matter discussed herein. In this diagram, one can see several personal computing devices 120A-120C, each coupled to the network 170 (i.e., the internet). Further, each computing device 120A-120C may further include an application 201A-201C executing thereon. The application 201A-201C may be browser-based service software or a standalone application installed at the local computing device. The local application 201A-201C may be configured to interface with a server application 213 executing on a server computer 160 also coupled to the network 170. The server application 213 may store data is a server-based data store 214.

The local applications 201A-201C together with the server application 213 may provide a user of one of the computing device 201A-201C with a user experience whereby access to and participation in a questionnaire-based activity may be scored and ranked against other similar users undertaking similar activity. For example, (an example that will continue throughout this disclosure), a group of users may each choose to participate in an awards prediction pool focused on an annual movie awards show (e.g., the Oscars™ from the Academy of Motion Picture Arts and Sciences). In this example, each user at each computing device 201A-201C may browse to a browser-based application or install a local application whereby each user is able to enter predictions across a group of presented categories along with a list of possible predictions. That is, in movie awards shows, there are often multiple categories such as best movie, best actress, best song from a movie, etc. Further, there tend to be several nominations in each category, As such, each user may enter predictions at the local computing device and upload the user's set of predictions to the server computer 160 to be stored at the server computer data store 214.

Then, as the awards are announced, a two-tiered weighting of correct and incorrect predictions may be assembled at the server computer service application 213. Specific details of the two-tiered weighting system are described further below. However, as the awards show unfolds, a ranking of all users who have entered predictions may be updated and downloaded back to each personal computing environment 201A-201C for display on a local display (not shown in FIG. 2). In this manner, users may see in real time, scores ranked against others associated with a smaller group of users or against all users in the aggregate. These basic parameters of a two-tiered weighting system are described further with respect to various flow chart diagrams of FIGS. 3-5.

FIG. 3 is a flow chart diagram of method 300 for establishing a questionnaire-based survey within the context of a questionnaire-based two-tiered weighting system according to an embodiment of the subject matter disclosed herein. In an embodiment, a coordinator or administrator of questionnaire-based contest or pool may establish specific sets of categories and weightings of such categories. Such a method may begin at step 301.

Next, an administrator may establish each category that will be used in the contest or pool at step 304. For example, in the running example embodiment, the administrator may select twenty movie award categories including best actor, best actress, best movie, best director, etc. Then, at step 305, each category established may be given a weighting relative to all other categories. In one example, the weighting may be likened to a course credit load for common grading systems in an academic setting. That is, a relatively important category (as defined by an administrator), may be weighted equivalent to a four credit course (e.g., a weighting of 4) whereas a less important category (again, simply as defined by an administrator) may be weighted equivalent to a one credit course. The use of credit and course analogy here is strictly for ease or explanation and does not limit the weighting of any category to fit within any context of academia. Nevertheless, it is a simple analogy to use to provide further explanation behind a weighting algorithm for various categories in a questionnaire-based contest of pool. Thus, this weighting by category may be referred to as a first-tier weighting.

In addition to the category selection and weighting in steps 304 and 305, an administrator may also establish rankings within each category based on the kind of category that is selected. Thus, at step 310, an administrator may assign rankings within each category such that overall answers to the questionnaire based category may allow for 1^{st}, 2^{nd}, 3^{rd} . . . n^{th} choices within the category. For example, in the running example embodiment using movie awards, in a category for best movie, five movies may have been nominated to win the award: A) Dances with Spiders, B) To Mimic A Mocking Jay, C) Silence of the Lawyers, D) One Flew over the White House, and E) Midnight in the Lawn of Pride and Pandora. The administrator may assign ranking values for the answers within the category such that a contestant would rank the answers in order of likelihood of winning the award. Thus, a contestant may, when filling out the questionnaire (as described below with respect to FIG. 4), predict, in a first position, that the most likely movie to win the award is C) Silence of the Lawyers, in a second position, the second most likely movie to win the award is D) One flew over the White House, etc. . . . all the way through each nominated film. Thus, the administrator may assign point values for correctly predicting the winner in the first position, second position, third position, etc.

Further, the administrator may assign a weighting to the point values based on the ranked position in the prediction in step 311. Thus, for each position a different weighting may be applied as a second tier weighting. To further the previous academic analogy, a contestant who correctly predicts the winner of the category in the first position may be awarded points weighted equivalent to an A in a typical A-B-C-D-F grading system. A contestant who predicts the category winner in the second position may be awarded a weighted score equivalent to a B. This may be extended in any manner down to a zero weighting for having the winner of the category in the last position for the category.

Thus, the administrator may establish a first tier weighting on a per category basis and a second tier weighting on an intra-category basis. The administrator may then further assign additional parameters to the contest or pool being established at step 320. Such additional parameters may include the use of wild card categories wherein the administrator may secretly establish the categories as worth more than others. Other additional parameters may include linking categories together such that one category score may be dependent upon another category. Further parameters may include all-or-nothing categories such that only the prediction in the first position will be scored. Other additional parameters may also be established by the administrator. After establishing the contest or pool, the administrator may affect a communication to various users notifying them of the pending contest or pool at step 330 before this portion of an overall method ends at step 340. Then, users may continue the contest or pool by making predictions as discussed further below with respect to FIG. 4.

FIG. 4 is a flow chart diagram of method 400 for making predictions within the context of a questionnaire-based two-tiered weighting system according to an embodiment of the subject matter disclosed herein. Such a method 400 may be implemented by a user, contestant, or participant (hereinafter, user) in the contest established by an administrator. The user may be operating a personal computer as described previously with an application executing thereon with computer-readable instructions for implementing such a method. Further, the computer-executable instructions may or may not be within the context of web-browser software and may or may not be service based.

The method may start at step 401 and a user may be notified of a pending contest that has been established by an administrator whereby a user may initiate an application for making predictions at step 410. The user may then, at step 412, select a first of several categories established by the administrator for making predictions. Once a category is selected, the user may then rank predictions, at step 414, according to position such that ranking a selection in the category in the first position indicates the user's prediction that this selection is the most likely to win the category. The user continues ranking selections in 2^{nd}, 3^{rd}, n^{th} position indicating second-most likely, third most likely, nth most likely predictions to win the category.

Next, a decision block 416 indicates whether there are additional categories to rank. If there are more categories or the user wishes to revisit a category to change rankings, the method loops back to the category selection step 412. If there are no more rankings to be made, the method proceeds to step 418 where the user can lock in the predictions and establish login credentials in order to return to any service-based applications at a later time. Lastly, the user's predictions are uploaded, at step 420 to a server computer and complied within a grouping of competitors according to the administrator's established contest. This portion of an overall method ends at step 422. After all users who wish to participate in the contest have finalized and uploaded answers to the server computer, the contest may proceed and be scored according to a method as discussed below with respect to FIG. 5.

FIG. 5 is a flow chart diagram of method 500 for updating and presenting results within the context of a questionnaire-based two-tiered weighting system according to an embodiment of the subject matter disclosed herein. Once the administrator has established the contest and users have made predications, the contest may proceed, typically according to a remote schedule associated with the specific awards show or sporting event in which the contest is based. Thus, as the event unfolds, users' predictions can be evaluated and scored according to the established two-tiered weighting system of the established contest. Thus, the evaluating and updating may begin at step 501.

Once started, various categories will be selected for award announcement, typically at the behest of the awards organizers. In concert with the awards announcements, an administrator may too select the next-to-be-announced award amongst the categories for awards at step 510. Then, as an award winner is announced, the administrator may then also establish the award winner in the context of the contest at step 512. Further, steps 510 and 512 may also be automated in conjunction with the organizers of the awards shows such that the administrator need not participate in the administration of the contest during the announcing of category winners.

Regardless of how the winner in a category is established in the context of the contest, the method then continues to step 514 where a first tier weighting is established within the category rankings per user. As discussed above, each user had entered predictions rankings for each category. Thus, depending on where a user ranked the eventual winner, a weighting of first position, second position, n^{th} position is awarded an initial score. Then at step 516, a second tier weighting is applied based on the weighting of the overall category. To further the academic analogy, the user may have earned an “A” on a category by predicting the eventual winner in the first position thereby earning an initial first tier weighted score of 4.0. Then, the category may be considered to be worth three credit hours, thereby earning the user a score of 12.0 points after the second tier weighting is applied.

Next, at step 518, the combined first and second tier weighting may be normalized to a scale more easily understood than raw scores. That is, instead of ranking various users according to raw score, the raw score may be normalized to a more familiar scale such as 0-100 or a common academic 4.0 grade point average (GPA) scale. In this manner, as the database at the server is updated and scores are displayed (step 520) at any users' computer displays who are executing the software, users may more easily understand the composite rankings of all contestants on a familiar GPA.

At decision block 522, it is determined whether additional categories remain to be announced, in which case, the method loops back to the category selection step 510 and the process repeats until categories are exhausted. When categories are exhausted, the final results may be tabulated at step 524 before the method ends at step 526. These methods as discussed in FIGS. 3-5 may be better understood with respect to a common screen shot of a display that tabulates results during the contest as described with respect to FIG. 6.

FIG. 6 is a screen shot 600 of a ranking of users in the context of a two-tiered weighting system for questionnaire analysis according to an embodiment of the subject matter disclosed herein. In this example, three users have entered predictions in three movie award categories, best movie, best actress, and best song. An administrator may have established this contest with only these three categories in this example. Further, the administrator may have established different category weighting for these categories wherein the best movie award category is weighted as worth 10, the best actress category is weighted as worth 4, and the best song category is weighted as worth 2. Further, the administrator may have established ranking weightings as having a point value of 4.0 for first position, 3.0 for second position, 2.0 for third position, 1.0 for fourth position and 0.0 for fifth position.

As users make predications, this display may be updated with the various users' predications. Here there are three users, Sarah, Michael and Keller. Each category shows ranked predictions from each user as selections 1, 2, 3, 4, and 5 (which are not related to common grading indicators). Then as category winners are announced, the winning candidates corresponding letter may be populated in the answer column.

Then, each user may have a first-tier weighted score corresponding to the position of the users' ranked answers. Thus, Sarah receives a grade score of an “A” (e.g., 4.0 weighted score) for predicting the winning answer 1 in the first position. Differently, both Michael and Keller receive a grade score of “B” (e.g., 3.0) for predicting the winner answer 1 in the second position. Then, each grade score may be further weighted in a second tier based on the weight of the category for best movie. In this scenario, best movie is worth a value of 10. Thus, Sarah receives 40 points for getting an “A” in this category, while Michael and Keller receive 30 points for getting a “B.”

As each of the other categories is scored in the two-tiered weighting system, the aggregate scores for each user may be normalized to a scale more easily recognized. In this scenario, the normalization occurs to a common 4.0 GPA scale. Thus, after three categories, Sarah has a GPA score of 3.25 while Michael and Keller each have a GPA score of 3.375.

The above-described examples have all been within the context of a movie awards show example and using a GPA type analogy for scoring and ranking. However, several permutations to these examples exist. Different ranking algorithms may be employed such that only the top-two positions gain points and the various points awarded need not necessarily correspond to common grading systems in academic scenarios. Further, the methods may be applied to other contest-like settings such as sporting events involving a tournament style of play, sporting seasons where individual players and teams win awards such as MVP, scoring titles, etc. Such a system may be further applied to team sports in users predicting orders by which teams will finish the season within leagues or divisions.

As another example, the systems and methods described herein have application in the context of political races or reality television shows whereby pundits may compete with each other in predicting various political races or reality show winners during an election season or television season. Various races and contests may have different weighting based on the race itself as well as rankings of candidates and how they may finish. A third tier weighting may be applied to predictions of point spreads between a top-vote candidate and second place candidate or in a time-value setting whereby additional weight may be given to predictions made sooner rather than later. Thus, a time factor may be involved in the weighting of any of the afore-mentioned first, second, or third tiers. In still further applications, predictions of stock values and stock dividends may be predicted and weighted by tiers in the systems and methods described herein. Additionally, placement tests and aptitude assessments may have differently weighted questions having different weighted rankings with the questions.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. A computing system, comprising:
a computing device configured to receive a plurality of sets of predictions corresponding to a set of events, each predication in each set of predications including an ordering of a plurality of possible outcomes for each event in the set of events; and
a ranking module configured to display, on a computing device display, a ranking of the sets of predictions based upon a weighting of each predication and a weighting of the ordering of each predication.

2. The computing system of claim 1, wherein the computing device further comprises a server computer accessible via a computer network.

3. The computing system of claim 2, wherein the computing display comprises a display associated with a personal computer that is communicatively coupled to the server computer via the computer network.

4. The computing system of claim 1, wherein the weightings of each prediction comprises one of a plurality of values.

5. The computing system of claim 1, wherein the ranking module is further configured to rank sets of predications based on a third-tier weighting based on a time value corresponding to when a set of predictions is received at the computing device.

6. The computing system of claim 1, wherein the ranking module is further configured to normalize the ranking to a specific scale.

7. The computing system of claim 6, wherein the scale is a grade point average scale.

8. The computing system of claim 1, wherein the event comprises a movie awards show.

9. The computing system of claim 1, wherein the event comprises an election.

10. The computing system of claim 1, wherein the event comprises a reality television program.

11. The computing system of claim 1, wherein the event comprises a sporting event.

12. A computer system, comprising:
a server computer coupled to a computer network, the server computer further including:
a computing device configured to receive a plurality of sets of predictions corresponding to a set of events, each predication in each set of predications including an ordering of a plurality of possible outcomes for each event in the set of events; and
a ranking module configured to display, on a computing device display, a ranking of the sets of predictions based upon a weighting of each predication and a weighting of the ordering of each predication; and
at least one remote computer coupled to the server computer via the computer network, the at least one remote computer further comprising the computing device display.

13. The computer system of claim 12, further comprising a second remote computer coupled to the server computer and configured to provide outcomes to the server computer.

14. The computer system of claim 12, wherein the server computer is further configured to provide an update to the at least one remote computer in response to a determination of an outcome.

15. A computing method, comprising:
establishing a contest having a plurality of categories, each having a plurality of possible outcomes for each category;
receiving a plurality of predictions from a plurality of users for the plurality of categories and the plurality of possible outcomes;
determining an outcome for each category;
ranking the plurality of predictions based on a first tier weighting of the categories and a second tier weighting of the possible outcomes for each category; and
communicating the ranking to each of the plurality of users.

16. The method of claim 15, wherein each of the plurality of predictions further comprises a category and an order of possible outcomes in each category.

17. The method of claim 15, wherein each of the plurality of predictions further comprises a category and a point spread between possible outcomes in each category.

18. The method of claim 15, further comprising ranking the plurality of predictions based on a third tier weighting corresponding to a time frame.

19. The method of claim 15, further comprising communicating the ranking to each of the plurality of users each time an outcome is determined for each category.

20. The method of claim 15, further comprising normalizing the ranking of the plurality of predictions to a grade point average scale.
